(19) United States
(12) Patent Application Publication
(10) Pub. No.: US 2025/0239881 A1
(43) Pub. Date: Jul. 24, 2025

(54) ELECTRICAL CIRCUIT AND NON-TRANSITORY STORAGE MEDIUM STORING PROGRAM FOR PARALLEL CHARGING START PROCESSING

(71) Applicant: TOYOTA JIDOSHA KABUSHIKI KAISHA, Toyota-shi (JP)

(72) Inventors: Fumiyoshi KURIBARA, Toyota-shi (JP); Jinwoo Kim, Nisshin-shi (JP); Fumitoshi Murase, Toyota-shi (JP)

(73) Assignee: TOYOTA JIDOSHA KABUSHIKI KAISHA, Toyota-shi (JP)

(21) Appl. No.: 19/019,684

(22) Filed: Jan. 14, 2025

(30) Foreign Application Priority Data
Jan. 24, 2024 (JP) 2024-008799

(51) Int. Cl. H02J 7/14; H02J 7/00; H02J 7/16

(52) U.S. Cl. CPC H02J 7/1423; H02J 7/0045; H02J 7/163; H02J 2310/40

(57) ABSTRACT

A vehicle mounted electrical circuit, wherein a parallel charging start processing includes a process of discharging a high-voltage capacitor via an inverter circuit and a three-phase motor in a state in which a connection switching circuit is controlled to stop voltage application from a serial circuit of a first battery and a second battery to the high-voltage capacitor, a process of charging the high-voltage capacitor by applying an output voltage of the first battery to the high-voltage capacitor, and a process of charging the first battery and the second battery in parallel by controlling a connection switching circuit such that a first battery is connected between the high-potential wiring and the low-potential wiring, a second battery between the neutral point and the low-potential wiring is connected, and a charging voltage generated by electric power supplied from an external charging facility is applied between the high-potential wiring and the low-potential wiring.

### CROSS-REFERENCE TO RELATED APPLICATION

This application claims priority to Japanese Patent Application No. 2024-008799 filed on Jan. 24, 2024 incorporated herein by reference in its entirety.

### BACKGROUND

### 1. Technical Field

The technology disclosed in the present specification relates to an electrical circuit and a non-transitory storage medium storing a program for parallel charging start processing.

### 2. Description of Related Art

Japanese Unexamined Patent Application Publication No. 2020-120566 (JP 2020-120566 A) discloses an electrical circuit installed in a vehicle. This electrical circuit has a serial circuit for two batteries, an inverter circuit, and a three-phase motor. The inverter circuit drives the three-phase motor by converting direct current electric power supplied from the serial circuit of the batteries to alternating current electric power and supplying the alternating current electric power to the three-phase motor. This electrical circuit also has wiring that connects a connection point of the two batteries and a neutral point of the coils of the three-phase motor. Temperature of each battery can be raised by transferring electric power between the two batteries via this wiring.

### SUMMARY

A capacitor (hereinafter referred to as “high-voltage capacitor”) is provided between high-potential wiring and low-potential wiring of the inverter circuit. Also, in an electrical circuit in which wiring is connected to the neutral point of the three-phase motor, there are cases in which a capacitor (hereinafter, referred to as “low-voltage capacitor”) is connected between the neutral point and the low-potential wiring. In this type of electrical circuit, there are cases in which processing of charging each battery in parallel by an external charging facility is executed from a state in which output voltage of the serial circuit of the two batteries is applied to the high-voltage capacitor. In this case, in conventional processing, first, the high-voltage capacitor and the low-voltage capacitor are discharged. Next, one battery is connected to the high-voltage capacitor, and the other battery is connected to the low-voltage capacitor. Thereafter, supply voltage of the external charging facility is applied to each battery in parallel, thereby charging each battery. According to this processing, voltage of each capacitor can be adjusted to an appropriate voltage corresponding to the battery, and an inrush current from the high-voltage capacitor when the connection of the circuit is changed can be suppressed from occurring. However, in this processing, there is a problem that the amount of time required for changing the connection of the circuit is long. For this reason, there are cases in which a time-out error occurs due to exceeding reception standby time of the external charging facility. The present specification proposes technology that is capable of starting parallel charging of a battery in a shorter time.

An electrical circuit disclosed in the present specification is installed in a vehicle. The electrical circuit includes
a first battery,
a second battery,
a high-voltage capacitor,
a low-voltage capacitor,
a three-phase motor, an inverter circuit, a charging port, a connection switching circuit, and
a control circuit.

The three-phase motor includes three windings of a U-phase winding, a V-phase winding, and a W-phase winding, each of the three windings including a first connection terminal provided at one end of the winding and a second connection terminal provided at another end of the winding, with the second connection terminals of the three windings being connected to each other at a neutral point.

The inverter circuit is connected to the first connection terminal of the U-phase winding, the first connection terminal of the V-phase winding, and the first connection terminal of the W-phase winding.

The charging port is for being connected to an external charging facility.

The connection switching circuit changes interconnection of the first battery, the second battery, the inverter circuit, the neutral point, and the charging port.

The inverter circuit includes
a high-potential wiring,
a low-potential wiring, and
three serial switch circuits provided for each of the three windings.

Each of the serial switch circuits includes an upper reverse conduction switching element that is a reverse conduction switching element connected between the first connection terminal of a corresponding winding and the high-potential wiring, and a lower reverse conduction switching element that is a reverse conduction switching element connected between the first connection terminal of the corresponding winding and the low-potential wiring.

The high-voltage capacitor is connected between the high-potential wiring and the low-potential wiring.

The low-voltage capacitor is connected between the neutral point and the low-potential wiring.

When an external charging facility is connected to the charging port during execution of a serial operation in which the connection switching circuit is controlled such that an output voltage of a serial circuit of the first battery and the second battery is applied to the high-voltage capacitor, the control circuit executes parallel charging start processing.

The parallel charging start processing includes
processing of discharging the high-voltage capacitor via the inverter circuit and the three-phase motor in a state in which the connection switching circuit is controlled such that voltage application from the serial circuit to the high-voltage capacitor is stopped, processing of charging the high-voltage capacitor by controlling the connection switching circuit such that an output voltage of the first battery is applied to the high-voltage capacitor, and
processing of charging the first battery and the second battery in parallel, in a state in which the first battery is connected between the high-potential wiring and the low-potential wiring, and the second battery is connected between the neutral point and the low-potential wiring, by controlling the connection switching circuit such that charging voltage generated by electric power supplied from the external charging facility to be applied across the high-potential wiring and the low-potential wiring.

Note that the charging voltage may be voltage supplied from the external charging facility to the charging port, or may be voltage obtained by converting voltage supplied from the external charging facility to the charging port (e.g., a direct current voltage converted from an alternating current voltage).

In the parallel charging start processing of this electrical circuit, parallel charging of the first battery and the second battery is executed after discharging of the high-voltage capacitor, and charging of the high-voltage capacitor by the first battery. Charging and discharging of the low-voltage capacitor are not performed, and accordingly parallel charging of the battery can be started in a short time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit diagram of an electrical circuit according to an embodiment; and

FIG. 2 is a flowchart of a parallel charging start processing.

### DETAILED DESCRIPTION OF EMBODIMENTS

In the above-described electrical circuit, the parallel charging start processing may be executed when the charging voltage is less than the output voltage of the serial circuit.

In the above-described electrical circuit, the series operation may be an operation of alternately performing a processing of transferring electric power from the first battery to the second battery via the inverter circuit and the three-phase motor, and a processing of transferring electric power from the second battery to the first battery via the inverter circuit and the three-phase motor.

According to this configuration, the temperature of each battery can be increased during the series operation.

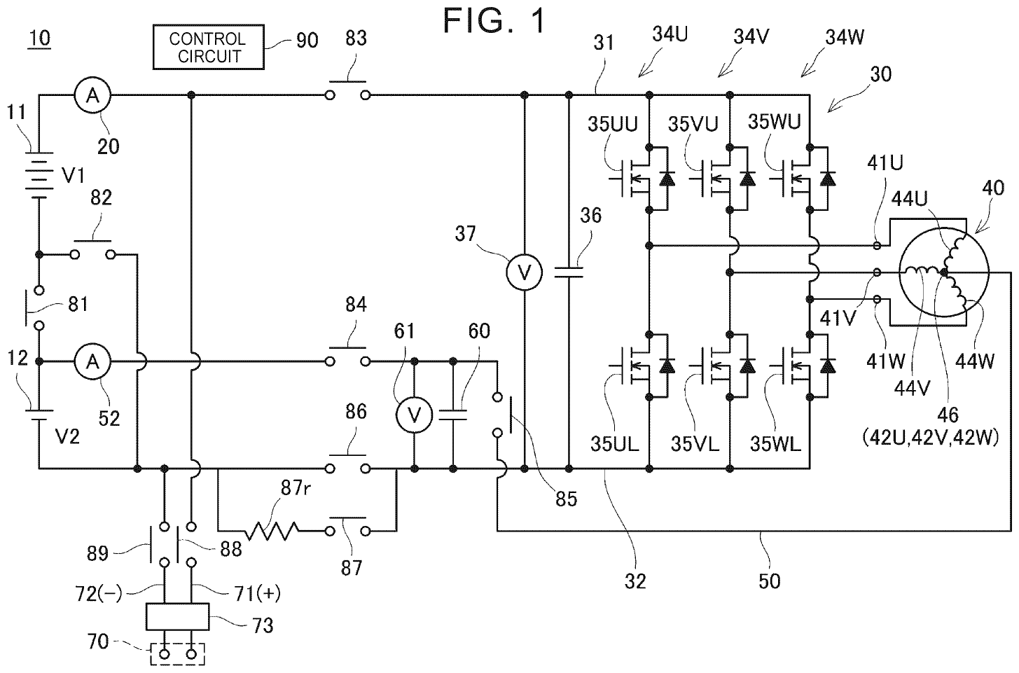

The electrical circuit 10 shown in FIG. 1 is mounted on a vehicle. The electrical circuit 10 includes a first battery 11, a second battery 12, an inverter circuit 30, and a three-phase motor 40. The three-phase motor 40 is a driving motor of the vehicle. The inverter circuit 30 converts the DC power supplied from the first battery 11 and the second battery 12 into AC power and supplies the AC power to the three-phase motor 40. As a result, the three-phase motor 40 rotates the drive wheels, and the vehicle travels. The output voltage V1 of the first battery 11 is substantially equal to the output voltage V2 of the second battery 12.

The three-phase motor 40 has a U-phase winding 44U, a V-phase winding 44V, and a W-phase winding 44W. Terminal 41U and terminal 42U are provided at both ends of the winding 44U. Terminal 41V and terminal 42V are provided at both ends of the winding 44V. Terminal 41W and terminal 42W are provided at both ends of the winding 44W. The terminals 42U, 42V, 42W are connected to each other at a neutral point 46.

The inverter circuit 30 is connected to the terminal 41U, 41V, 41W of the three-phase motor 40. The inverter circuit 30 includes a high-potential wiring 31, a low-potential wiring 32, and three serial switch circuits 34U, 34V, 34W. Each of the serial switch circuits 34U, 34V, 34W includes two reverse-conduction switching elements 35 connected in series between the high-potential wiring 31 and the low-potential wiring 32. In the following description, of the two reverse conduction switching elements 35 connected in series, the one connected to the high-potential wiring 31 is referred to as an upper reverse conduction switching element, and the one connected to the low-potential wiring 32 is referred to as a lower reverse conduction switching element. The reverse conduction switching elements 35 have a configuration in which switching elements (for example, insulated gate bipolar transistors or field-effect transistors) and diodes (for example, pn diodes or Schottky barrier diodes) are connected in anti-parallel. In each reverse conduction switching element 35, the cathode of the diode is connected to the high potential terminal (i.e., collector or drain) of the switching element. Also, the anode of the diode is connected to the low potential terminal (i.e., emitter or source) of the switching element.

The serial switch circuit 34U is provided for the winding 44U. The serial switch circuit 34U has an upper reverse conduction switching element 35UU and a lower reverse conduction switching element 35UL. The high potential terminal of the upper reverse conduction switching device 35UU is connected to the high potential wiring 31. The low potential terminal of the upper reverse conduction switching element 35UU and the high potential terminal of the lower reverse conduction switching element 35UL are connected to the terminal 41U. The low potential terminal of the lower reverse conduction switching device 35UL is connected to the low-potential wiring 32.

The serial switch circuit 34V is provided for the winding 44V. The serial switch circuit 34V has an upper reverse conduction switching element 35VU and a lower reverse conduction switching element 35VL. The high potential terminal of the upper reverse conduction switching device 35VU is connected to the high potential wiring 31. The low potential terminal of the upper reverse conduction switching element 35VU and the high potential terminal of the lower reverse conduction switching element 35VL are connected to the terminal 41V. The low potential terminal of the lower reverse conduction switching device 35VL is connected to the low-potential wiring 32.

The serial switch circuit 34W is provided for the winding 44W. The serial switch circuit 34W has an upper reverse conduction switching element 35WU and a lower reverse conduction switching element 35WL. The high potential terminal of the upper reverse conduction switching device 35WU is connected to the high potential wiring 31. The low potential terminal of the upper reverse conduction switching element 35WU and the high potential terminal of the lower reverse conduction switching element 35WL are connected to the terminal 41W. The low potential terminal of the lower reverse conduction switching device 35WL is connected to the low-potential wiring 32.

A high-voltage capacitor 36 is connected between the high-potential wiring 31 and the low-potential wiring 32. A voltmeter 37 is connected between the high-potential wiring 31 and the low-potential wiring 32.

A neutral point wiring 50 is connected to the neutral point 46 of the three-phase motor 40. The neutral point wiring 50 is connected to the positive electrode of the second battery 12. A low-voltage capacitor 60 is connected between the neutral point wiring 50 and the low-potential wiring 32. A voltmeter 61 is connected between the neutral point wiring 50 and the low-potential wiring 32.

The electrical circuit 10 has a charging port 70. A connector of a charging facility outside the vehicle can be connected to the charging port 70. An AC voltage is applied to the charging port 70 from an external charging facility. The charging port 70 is connected to the conversion circuit 73. When an AC voltage is applied to the charging port 70, the conversion circuit 73 converts the AC voltage into a DC voltage and outputs the DC voltage to the output wirings 71 and 72. The conversion circuit 73 outputs a DC voltage in a direction in which the output wiring 71 has a higher potential than the output wiring 72.

The electrical circuit 10 includes a plurality of relay switches 81 to 89. When the relay switches are switched, the interconnections of the first battery 11, the second battery 12, the high-potential wiring 31, the low-potential wiring 32, the neutral point 46, and the charging port 70 are changed. That is, the relay switches 81 to 89 constitute a connection switching circuit.

The relay switch 81 is provided between the negative electrode of the first battery 11 and the positive electrode of the second battery 12. When the relay switch 81 is turned on, the first battery 11 and the second battery 12 are connected in series.

The relay switch 82 is provided between the negative electrode of the first battery 11 and the negative electrode of the second battery 12. When the relay switch 82 is turned on, the negative electrode of the first battery 11 and the negative electrode of the second battery 12 are connected.

An ammeter 20 and a relay switch 83 are provided in series between the positive electrode of the first battery 11 and the high-potential wiring 31. When the relay switch 83 is turned on, the positive electrode of the first battery 11 is connected to the high-potential wiring 31.

A relay switch 84, an ammeter 52, and a relay switch 85 are provided in the neutral point wiring 50. The relay switch 84 and the ammeter 52 are provided in the neutral point wiring 50 between the low-voltage capacitor 60 and the battery 12. The relay switch 85 is provided in the neutral point wiring 50 between the low-voltage capacitor 60 and the neutral point 46. When the relay switches 84 and 85 are turned on, the positive electrode of the second battery 12 is connected to the neutral point 46 via the neutral point wiring 50.

The relay switch 86 is provided between the negative electrode of the second battery 12 and the low-potential wiring 32. When the relay switch 86 is turned on, the negative electrode of the second battery 12 is connected to the low-potential wiring 32.

A series-circuit of a relay switch 87 and a resistor 87r is connected in parallel to the relay switch 86. When the relay switch 87 is turned on, the negative electrode of the second battery 12 is connected to the low-potential wiring 32 via the resistor 87r.

The relay switch 88 is provided between the positive electrode of the first battery 11 and the output wiring 71. When the relay switch 88 is turned on, the output wiring 71 is connected to the positive electrode of the first battery 11.

The relay switch 89 is provided between the negative electrode of the second battery 12 and the output wiring 72. When the relay switch 89 is turned on, the output wiring 72 is connected to the negative electrode of the second battery 12.

The electrical circuit 10 includes a control circuit 90. The control circuit 90 includes CPU, memories, and the like. A program for controlling the electrical circuit 10 is stored in the memory (storage medium) of the control circuit 90. The control circuit 90 controls the switching elements of the reverse conduction switching elements 35 and the relay switches 81 to 89 in accordance with the program.

In normal operation, the control circuit 90 turns on the relay switches 81, 83, and 86 and turns off the relay switches 82, 84, 85, 87, 88, and 89. In this state, the first battery 11 and the second battery 12 are connected in series between the high-potential wiring 31 and the low-potential wiring 32. Therefore, the output voltage V3 output from the serial circuit of the first battery 11 and the second battery 12 is applied between the high-potential wiring 31 and the low-potential wiring 32. The output voltage V3 is a voltage obtained by adding the output voltage V1 of the first battery 11 and the output voltage V2 of the second battery 12. The control circuit 90 switches the switching elements of the reverse conduction switching elements 35 to convert the DC power applied between the high-potential wiring 31 and the low-potential wiring 32 into AC power, and supplies the AC power to the three-phase motor 40. This causes the three-phase motor 40 to rotate. The control circuit 90 controls the torque and the rotation speed of the three-phase motor 40 by changing the amplitude, frequency, and the like of the alternating current supplied to the three-phase motor 40.

The control circuit 90 can execute the battery temperature raising operation while the vehicle is stopped. For example, in a low-temperature environment, the performance of the batteries 11 and 12 can be improved by raising the temperature of the batteries 11 and 12 by the battery temperature raising operation. In the battery temperature raising operation, the control circuit 90 causes the inverter circuit 30 and the three-phase motor 40 to operate as a converter circuit. More specifically, in the battery temperature raising operation, the control circuit 90 causes at least one of the U-phase, the V-phase, and the W-phase to operate as a converter circuit. Since the U-phase, the V-phase, and the W-phase operate in the same manner, the operation of the U-phase will be described below.

In the battery temperature raising operation, the control circuit 90 turns on the relay switches 81, 83, 84, 85, and 86 and turns off the relay switches 82, 87, 88, and 89. In addition, the control circuit 90 switches the reverse conduction switching elements 35UU, 35UL according to conditions. When the reverse conduction switching element 35UU is turned on, a current flows from the positive electrode of the first battery 11 to the negative electrode of the first battery 11 via the high-potential wiring 31, the reverse conduction switching element 35UU, the winding 44U, and the neutral point wiring 50. When the reverse conduction switching device 35UU is turned off, an induced voltage is generated in the winding 44U. Consequently, a current flows from the negative electrode of the second battery 12 to the positive electrode of the second battery 12 via the low-potential wiring 32, the diode of the reverse-conduction switching device 35UL, the winding 44U, and the neutral point wiring 50. As described above, when the reverse conduction switching device 35UU is switched, the first battery 11 is discharged and the second battery 12 is charged, and electric power is transferred from the first battery 11 to the second battery 12. When the reverse conduction switching element 35UL is turned on, a current flows from the positive electrode of the second battery 12 to the negative electrode of the second battery 12 via the neutral point wiring 50, the winding 44U, the reverse conduction switching element 35UL, and the low-potential wiring 32. When the reverse conduction switching device 35UL is turned off, an induced voltage is generated in the winding 44U. Consequently, a current flows from the negative electrode of the first battery 11 to the positive electrode of the first battery 11 via the neutral point wiring 50, the winding 44U, the diode of the reverse-conduction switching device 35UU, and the high-potential wiring 31. As described above, when the reverse conduction switching device 35UL is switched, the second battery 12 is discharged and the first battery 11 is charged, and electric power is transferred from the second battery 12 to the first battery 11. In the battery temperature raising operation, the control circuit 90 alternately performs the power transfer from the first battery 11 to the second battery 12 and the power transfer from the second battery 12 to the first battery 11. Accordingly, the control circuit 90 increases the temperature of the first battery 11 and the temperature of the second battery 12.

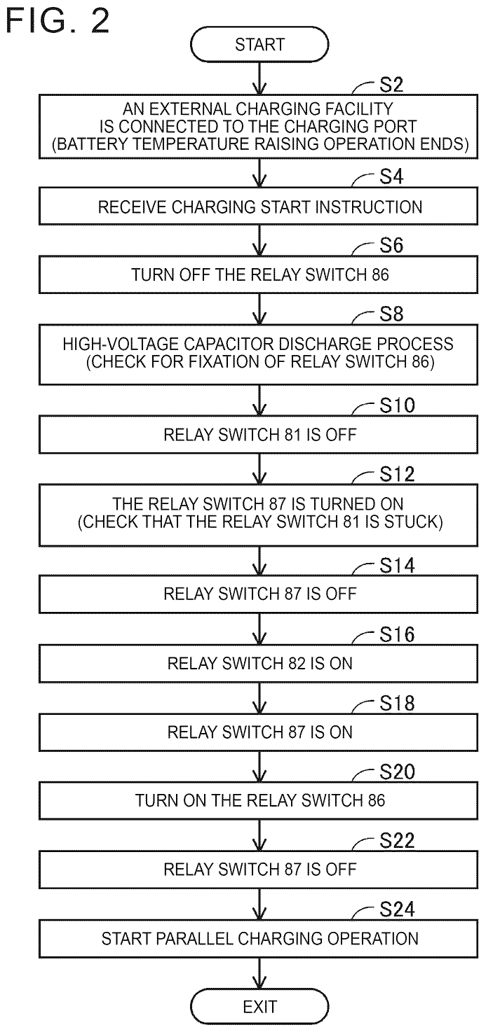

During the battery temperature raising operation, an external charging facility may be connected to the charging port 70, and charging of the batteries 11 and 12 may be started. Here, the charging voltage Vc output from the conversion circuit 73 between the output wirings 71 and 72 is lower than the output voltage V3 of the serial circuit of the batteries 11 and 12 and higher than the output voltage V1, V2 of the batteries 11 and 12. Therefore, the control circuit 90 performs an operation of charging the batteries 11 and 12 by applying a charging-voltage Vc to the batteries 11 and 12 in parallel (hereinafter, referred to as a parallel charging operation). When shifting from the battery temperature raising operation to the parallel charging operation, the control circuit 90 executes the parallel charging/charging start process illustrated in FIG. 2 in accordance with the program.

At the start of FIG. 2, the control circuit 90 executes a battery temperature raising operation. That is, at the start of FIG. 2, the relay switches 81, 83, 84, 85, and 86 are on, and the relay switches 82, 87, 88, and 89 are off. In this condition, the output voltage V3 of the series-circuit of the batteries 11 and 12 is applied to the high-voltage capacitor 36, and the output voltage V2 of the second battery 12 is applied to the low-voltage capacitor 60.

In S2, an external charging facility is connected to the charging port 70. Then, the control circuit 90 turns off all the reverse conduction switching elements 35 and ends the battery temperature raising operation. Thereafter, when the user performs a charging start operation in the external charging facility, the external charging facility transmits a charging start instruction to the control circuit 90. Therefore, in S4, the control circuit 90 receives the charge-start instruction. Thereafter, the control circuit 90 sequentially executes the processes after S6.

In S6, the control circuit 90 turns off the relay switch 86. This causes the potential of the low-potential wiring 32 to float. Even when the relay switch 86 is turned off, electric charges are held in each of the high-voltage capacitor 36 and the low-voltage capacitor 60. Therefore, after the relay switch 86 is turned off, the voltage across the high-voltage capacitor 36 is substantially equal to the output voltage V3, and the voltage across the low-voltage capacitor 60 is substantially equal to the output voltage V2.

Next, in S8, the control circuit 90 executes a high-voltage capacitor discharging process. Here, the control circuit 90 turns on the upper reverse conduction switching element 35 of one phase and the lower reverse conduction switching element 35 of another phase among the serial switch circuits 34U to 34W. The upper reverse conduction switching element 35UU and the lower reverse conduction switching element 35VL are turned on. Here, a current flows from the high-potential terminal of the high-voltage capacitor 36 to the low-potential terminal of the high-voltage capacitor 36 via the upper reverse-conduction switching element 35UU, the winding 44U, the winding 44V, and the lower reverse-conduction switching element 35VL. As a result, the high-voltage capacitor 36 is discharged. In the high-voltage capacitor discharge process, the control circuit 90 repeatedly switches at least one of the reverse conduction switching elements 35UU, 35VL to suppress the discharge current from being excessively high. The control circuit 90 discharges the high-voltage capacitor 36 until the voltage across the high-voltage capacitor 36 (i.e., the detected voltage of the voltmeter 37) is 0 V at S8. When the voltage across the high-voltage capacitor 36 drops to 0 V, the control circuit 90 turns off both of the reverse conduction switching elements 35UU, 35VL and terminates the high-voltage capacitor discharging process. Since the low-voltage capacitor 60 is not discharged in S8, the voltage across the low-voltage capacitor 60 is maintained at a voltage substantially equal to the output voltage V2 after S8 is completed.

Also, in general, the relay switch may not be able to be turned off due to the fixation of the contacts. When the relay switch 86 is not turned off due to the fixing, the voltage across the high-voltage capacitor 36 does not decrease in S8. Therefore, S8 also serves as a checking of the fixation of the relay switch 86. When the relay switch 86 is fixed, the control circuit 90 stops the processing.

Next, in S10, the control circuit 90 turns off the relay switch 81.

Next, in S12, the control circuit 90 turns on the relay switch 87. Further, the control circuit 90 monitors the voltage across the high-voltage capacitor 36 with a voltmeter 37. When the relay switch 81 is not turned off by fixing, when the relay switch 87 is turned on, the high-voltage capacitor 36 is charged by the serial circuit of the batteries 11 and 12, and the voltage across the high-voltage capacitor 36 rises. On the other hand, when the relay switch 81 is turned off, the voltage across the high-voltage capacitor 36 does not increase even when the relay switch 87 is turned on. Thus, S12 allows checking the fixation of the relay switch 81. When the relay switch 81 is fixed, the control circuit 90 stops the processing.

Next, in S14, the control circuit 90 turns off the relay switch 87, and ends the fixing checking with respect to the relay switch 81.

Next, in S16, the control circuit 90 turns on the relay switch 82. Thus, the negative electrode of the first battery 11 is connected to the negative electrode of the second battery 12.

Next, in S18, the control circuit 90 turns on the relay switch 87. As a result, the negative electrode of the first battery 11 and the negative electrode of the second battery 12 are connected to the low-potential wiring 32 via the resistor 87r. Then, the output-voltage V1 of the first battery 11 is applied to the high-voltage capacitor 36. Therefore, the high-voltage capacitor 36 is charged by the output-voltage V1. At this time, the charge current is suppressed from becoming extremely high by the resistor 87r. The control circuit 90 charges the high-voltage capacitor 36 until the voltage across the high-voltage capacitor 36 is equal to the output voltage V1. When the relay switch 87 is turned on, the output-voltage V2 of the second battery 12 is applied to the low-voltage capacitor 60. However, since the voltage across the low-voltage capacitor 60 is substantially equal to the output voltage V2 prior to the implementation of S18, the voltage across the low-voltage capacitor 60 hardly changes even if the relay switch 87 is turned on.

When the voltage across the high-voltage capacitor 36 rises to the output voltage V1, the control circuit 90 turns on the relay switch 86 at S20. Thus, the negative electrode of the first battery 11 and the negative electrode of the second battery 12 are directly connected to the low-potential wiring 32. When the relay switch 86 is turned on, the control circuit 90 turns off the relay switch 87 at a subsequent S22.

Next, the control circuit 90 starts the parallel charge operation in S24. That is, the control circuit 90 first instructs the external charging facility to start parallel charging. Then, the external charging facility applies an AC voltage to the charging port 70. Then, the conversion circuit 73 converts the AC voltage into the DC charging voltage Vc and outputs the DC charging voltage to the output wirings 71 and 72. The control circuit 90 turns on the relay switches 88 and 89. When controlled in this way, the first battery 11 is connected between the high-potential wiring 31 and the low-potential wiring 32, the second battery 12 is connected between the neutral point 46 and the low-potential wiring 32, and the charging voltage Vc is applied between the high-potential wiring 31 and the low-potential wiring 32.

A charging voltage Vc is applied to the first battery 11. As described above, the charging voltage Vc is higher than the output voltage V1 of the first battery 11. Therefore, the first battery 11 is charged.

In the parallel charge operation, the control circuit 90 turns on at least one of the upper reverse conduction switching elements 35UU, 35VU, 35WU. In the following, a case where the upper reverse conduction switching device 35UU is turned on will be described. When the upper reverse conduction switching element 35UU is turned on, the high-potential wiring 31 is connected to the positive electrode of the second battery 12 via the upper reverse conduction switching element 35UU, the winding 44U, and the neutral point wiring 50. Therefore, the charging voltage Vc is applied to the second battery 12. As described above, the charging voltage Vc is higher than the output voltage V2 of the second battery 12. Accordingly, the second battery 12 is charged. Note that the charge current for the second battery 12 may be reduced by repeatedly switching the upper reverse conduction switching device 35UU.

Thus, in the parallel charging operation, the first battery 11 and the second battery 12 are charged in parallel. Accordingly, the state of charge of the first battery 11 and the second battery 12 can be recovered.

As described above, in the parallel charge start process of FIG. 2, the high-voltage capacitor 36 can be discharged without charging and discharging the low-voltage capacitor 60, and then the first battery 11 can be connected to the high-voltage capacitor 36. Therefore, the preparation for the parallel charging operation for the batteries 11 and 12 can be completed in a short time. Therefore, it is possible to prevent a time-out error from occurring in the external charging facility due to a long preparation time.

In the above-described embodiment, the case where the battery temperature raising operation is shifted to the parallel charging operation has been described. However, the operating state before the parallel charging start processing is not limited to the battery temperature raising operation. That is, the operating state before the parallel charging start processing may be any operating state as long as the batteries 11 and 12 are connected in series, the output voltage V3 is applied to the high-voltage capacitor 36, and the output voltage V2 is applied to the low-voltage capacitor 60.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. An electrical circuit installed in a vehicle, the electrical circuit comprising:
a first battery;
a second battery;
a high-voltage capacitor;
a low-voltage capacitor;
a three-phase motor including three windings of a U-phase winding, a V-phase winding, and a W-phase winding, each of the three windings including a first connection terminal provided at one end of the winding and a second connection terminal provided at another end of the winding, with the second connection terminals of the three windings being connected to each other at a neutral point;
an inverter circuit connected to the first connection terminal of the U-phase winding, the first connection terminal of the V-phase winding, and the first connection terminal of the W-phase winding;
a charging port for being connected to an external charging facility;
a connection switching circuit for changing interconnection of the first battery, the second battery, the inverter circuit, the neutral point, and the charging port; and
a control circuit, wherein
the inverter circuit includes
a high-potential wiring,
a low-potential wiring, and
three serial switch circuits provided for each of the three windings,
each of the serial switch circuits includes an upper reverse conduction switching element that is a reverse conduction switching element connected between the first connection terminal of a corresponding winding and the high-potential wiring, and a lower reverse conduction switching element that is a reverse conduction switching element connected between the first connection terminal of the corresponding winding and the low-potential wiring,
the high-voltage capacitor is connected between the high-potential wiring and the low-potential wiring,
the low-voltage capacitor is connected between the neutral point and the low-potential wiring,
when an external charging facility is connected to the charging port during execution of a serial operation in which the connection switching circuit is controlled such that an output voltage of a serial circuit of the first battery and the second battery is applied to the high-voltage capacitor, the control circuit executes parallel charging start processing, and
the parallel charging start processing includes
processing of discharging the high-voltage capacitor via the inverter circuit and the three-phase motor in a state in which the connection switching circuit is controlled such that voltage application from the serial circuit to the high-voltage capacitor is stopped,
processing of charging the high-voltage capacitor by controlling the connection switching circuit such that an output voltage of the first battery is applied to the high-voltage capacitor, and
processing of charging the first battery and the second battery in parallel, in a state in which the first battery is connected between the high-potential wiring and the low-potential wiring, and the second battery is connected between the neutral point and the low-potential wiring, by controlling the connection switching circuit such that charging voltage generated by electric power supplied from the external charging facility to be applied across the high-potential wiring and the low-potential wiring.

2. The electrical circuit according to claim 1, wherein the control circuit executes the parallel charging start processing when the charging voltage is lower than output voltage of the serial circuit.

3. The electrical circuit according to claim 1, wherein the serial operation is an operation in which processing of transferring electric power from the first battery to the second battery via the inverter circuit and the three-phase motor, and processing of transferring electric power from the second battery to the first battery via the inverter circuit and the three-phase motor, are alternately performed.

4. A non-transitory storage medium storing a program that causes an electrical circuit installed in a vehicle to execute charging processing, the electrical circuit comprising:
a first battery;
a second battery;
a high-voltage capacitor;
a low-voltage capacitor;
a three-phase motor including three windings of a U-phase winding, a V-phase winding, and a W-phase winding, each of the three windings including a first connection terminal provided at one end of the winding and a second connection terminal provided at another end of the winding, with the second connection terminals of the three windings being connected to each other at a neutral point;
an inverter circuit connected to the first connection terminal of the U-phase winding, the first connection terminal of the V-phase winding, and the first connection terminal of the W-phase winding;
a charging port for being connected to an external charging facility;
a connection switching circuit for changing interconnection of the first battery, the second battery, the inverter circuit, the neutral point, and the charging port; and
a control circuit, wherein
the inverter circuit includes
a high-potential wiring,
a low-potential wiring, and
three serial switch circuits provided for each of the three windings,
each of the serial switch circuits includes an upper reverse conduction switching element that is a reverse conduction switching element connected between the first connection terminal of a corresponding winding and the high-potential wiring, and a lower reverse conduction switching element that is a reverse conduction switching element connected between the first connection terminal of the corresponding winding and the low-potential wiring,
the high-voltage capacitor is connected between the high-potential wiring and the low-potential wiring,
the low-voltage capacitor is connected between the neutral point and the low-potential wiring,
when an external charging facility is connected to the charging port during execution of a serial operation in which the connection switching circuit is controlled such that an output voltage of a serial circuit of the first battery and the second battery is applied to the high-voltage capacitor, the program causes the control circuit to execute parallel charging start processing, and
the parallel charging start processing includes
processing of discharging the high-voltage capacitor via the inverter circuit and the three-phase motor in a state in which the connection switching circuit is controlled such that voltage application from the serial circuit to the high-voltage capacitor is stopped,
processing of charging the high-voltage capacitor by controlling the connection switching circuit such that an output voltage of the first battery is applied to the high-voltage capacitor, and
processing of charging the first battery and the second battery in parallel, in a state in which the first battery is connected between the high-potential wiring and the low-potential wiring, and the second battery is connected between the neutral point and the low-potential wiring, by controlling the connection switching circuit such that charging voltage generated by electric power supplied from the external charging facility to be applied across the high-potential wiring and the low-potential wiring.
